(19) United States
(12) Patent Application Publication
(10) Pub. No.: US 2024/0069342 A1
(43) Pub. Date: Feb. 29, 2024

(54) SMART GLASSES AND OPERATION METHOD THEREOF

(71) Applicant: Electronics and Telecommunications Research Institute, Daejeon (KR)

(72) Inventors: Kwang-Yong KIM, Daejeon (KR); Kibong SONG, Daejeon (KR)

(73) Assignee: Electronics and Telecommunications Research Institute, Daejeon (KR)

(21) Appl. No.: 18/081,355

(22) Filed: Dec. 14, 2022

(30) Foreign Application Priority Data
Aug. 25, 2022 (KR) 10-2022-0107049

(51) Int. Cl. G02B 27/01; G06V 40/12

(52) U.S. Cl. CPC G02B 27/017; G06V 40/12; G02B 2027/0138; G02B 2027/0178

(57) ABSTRACT

Disclosed is an operation method of smart glasses, which includes displaying a key pad on a monitor in response to that a target object is recognized through a camera, identifying a reference area on the displayed key pad, which corresponds to a pointing area detected through the camera, recognizing a key value corresponding to the identified reference area, and performing a communication function based on the recognized key value.

### CROSS-REFERENCE TO RELATED APPLICATIONS

This application claims priority under 35 U.S.C. § 119 to Korean Patent Application No. 10-2022-0107049 filed on Aug. 25, 2022, in the Korean Intellectual Property Office, the disclosures of which are incorporated by reference herein in their entireties.

### BACKGROUND

Embodiments of the present disclosure described herein relate to smart glasses, and more particularly, relate to smart glasses that perform a communication function by recognizing a user's hand and an operation method thereof.

In general, a smartphone user always carries a smartphone for communication using the smartphone. In this case, the user may feel inconvenient because he or she must always carry the smartphone. Also, because the user always carries the smartphone, the probability that the smartphone will be lost is high.

In addition, for communication using the smartphone, the user must perform an operation of calling an application that is stored in the smartphone to support the communication function. As such, the user may feel inconvenient.

### SUMMARY

Embodiments of the present disclosure provide smart glasses that provide high convenience to a user and an operation method thereof.

According to an embodiment, an operation method of smart glasses may include displaying a key pad on a monitor in response to that a target object is recognized through a camera, identifying a reference area on the displayed key pad, which corresponds to a pointing area detected through the camera, recognizing a key value corresponding to the identified reference area, and performing a communication function based on the recognized key value.

In an embodiment, the target object may be a palm of the user of the smart glasses.

In an embodiment, the method may further include stopping displaying the key pad in response to that the palm of the user is not recognized through the camera.

In an embodiment, the identifying of the reference area may include identifying first coordinates corresponding to the pointing area on a frame photographed through the camera, identifying second coordinates on the key pad, which correspond to the first coordinates, and identifying the reference area corresponding to the second coordinates.

In an embodiment, the method may further include performing a shortcut function corresponding to the identified reference area, when the second coordinates are maintained during a first time length.

In an embodiment, the shortcut function may be a function of starting communication with a given phone number.

In an embodiment, the pointing area may be determined depending on a fingertip of the user.

In an embodiment, the pointing area may be determined in response to that the fingertip is in contact with the palm.

In an embodiment, the pointing area may be determined based on a curve in a skin of the palm, which is formed when the fingertip is in contact with the palm.

In an embodiment, the pointing area may be determined depending on a location of a recognition pad attached to a fingertip of the user.

In an embodiment, the monitor may be translucent or transparent.

In an embodiment, the key pad may be a telephone dial pad.

In an embodiment, a size of the key pad may be determined based on a size of the target object on a frame photographed through the camera.

According to an embodiment, smart glasses may include a camera that photographs a frame corresponding to the line of sight of a user, a processor that identifies a target object and a pointing area on the frame, a monitor that displays a key pad in response to that the target object is identified by the processor, and a communication module that performs a communication function based on a key value, and the key value may be determined based on a reference area on the key pad, which corresponds to the pointing area.

In an embodiment, the target object may be a palm of the user.

In an embodiment, the pointing area may be determined depending on a fingertip of the user.

In an embodiment, the monitor may stop displaying the key pad in response to that the target object is not recognized by the processor.

In an embodiment, the monitor may display the key pad to be translucent or transparent.

In an embodiment, a size of the key pad may be determined based on a size of the target object on a frame photographed through the camera.

In an embodiment, the communication module may perform the communication function complying with a communication protocol corresponding to one of GSM (Global System for Mobile communication), WCDMA (Wideband Code Division Multiple Access), LTE (Long Term Evolution), LTE-A (LTE-advanced), and NR (New Radio).

### BRIEF DESCRIPTION OF THE FIGURES

The above and other objects and features of the present disclosure will become apparent by describing in detail embodiments thereof with reference to the accompanying drawings.

FIG. 1 is a block diagram illustrating smart glasses according to an embodiment of the present disclosure.

FIG. 2 is a perspective view illustrating smart glasses illustrated in FIG. 1.

FIG. 3 is a diagram illustrating an operation in which smart glasses of FIG. 1 recognize a target object.

FIG. 4 is a diagram illustrating an operation in which a monitor of FIG. 1 displays a key pad when a target object is recognized.

FIG. 5 is a diagram illustrating an operation in which smart glasses of FIG. 1 determine a pointing area.

FIG. 6 is a diagram illustrating an operation in which smart glasses of FIG. 1 recognize an input key value based on a pointing area.

FIG. 7 is a flowchart illustrating an operation method of smart glasses of FIG. 1.

FIG. 8 is a flowchart illustrating operation S120 of FIG. 7 in detail.

### DETAILED DESCRIPTION

Below, embodiments of the present disclosure will be described in detail and clearly to such an extent that one skilled in the art easily carries out the present disclosure. In the following description, specific details such as detailed components and structures are merely provided to assist the overall understanding of embodiments of the present disclosure. Therefore, it should be apparent to those skilled in the art that various changes and modifications of the embodiments described herein may be made without departing from the scope and spirit of the invention. In addition, the descriptions of well-known functions and structures are omitted for clarity and brevity. In the following drawings or in the detailed description, components may be connected with any other components except for components illustrated in a drawing or described in the detailed description. The terms described in the specification are terms defined in consideration of the functions in the present disclosure and are not limited to a specific function. The definitions of the terms should be determined based on the contents throughout the specification.

Components that are described in the detailed description with reference to the terms “circuit”, “block”, etc. will be implemented with software, hardware, or a combination thereof. For example, the software may be a machine code, firmware, an embedded code, and application software. For example, the hardware may include an electrical circuit, an electronic circuit, a processor, a computer, integrated circuit cores, a pressure sensor, a micro electro mechanical system (MEMS), a passive element, or a combination thereof.

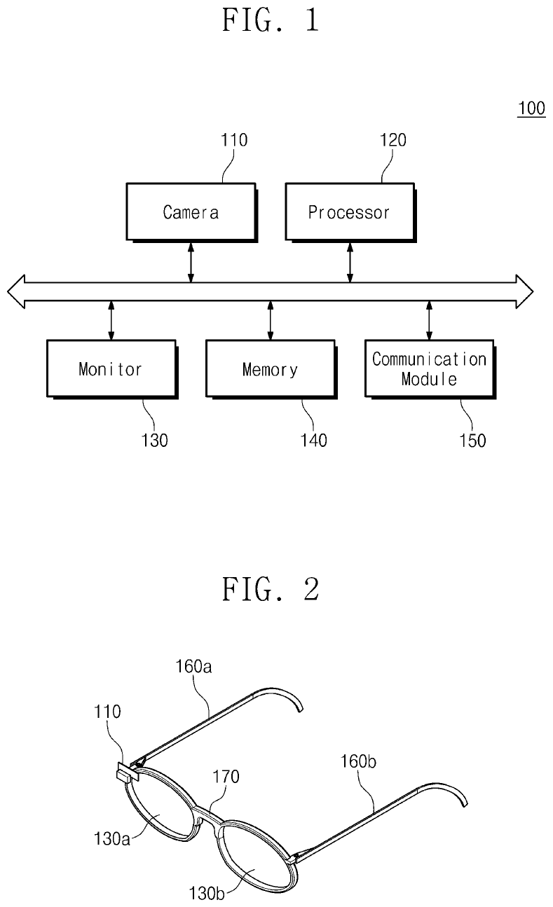

FIG. 1 is a block diagram illustrating smart glasses according to an embodiment of the present disclosure. Referring to FIG. 1, smart glasses 100 may include a camera 110, a processor 120, a monitor 130, a memory 140, and a communication module 150.

The smart glasses 100 may be equipped on a head of a user. The user may wear the smart glasses 100 so as to be close to the user's eyes.

The camera 110 may photograph a scene that the user views through the smart glasses 100. For example, a frame that the camera 110 photographs may correspond to the line of sight of the user. That is, an image included in the frame that the camera 110 photographs may be identical or similar to an image that the user views.

The processor 120 may be configured to perform a function of a central processing unit of the smart glasses 100. The processor 120 may control various operations of the smart glasses 100.

The monitor 130 may display data in the form of an image in the field of vision of the user. For example, the monitor 130 may be provided at a lens location of the smart glasses 100. In an embodiment, the monitor 130 may display data in a transparent or translucent form. In this case, the user may view the image over the smart glasses 100 as well as the data displayed on the monitor 130.

The processor 120 may determine whether a target object is included in the frame photographed through the camera 110. When it is determined that the target object is included in the frame, the processor 120 may control the monitor 130 to display a key pad. When it is determined that the target object is not included in the frame, the processor 120 may control the monitor 130 to stop displaying the key pad.

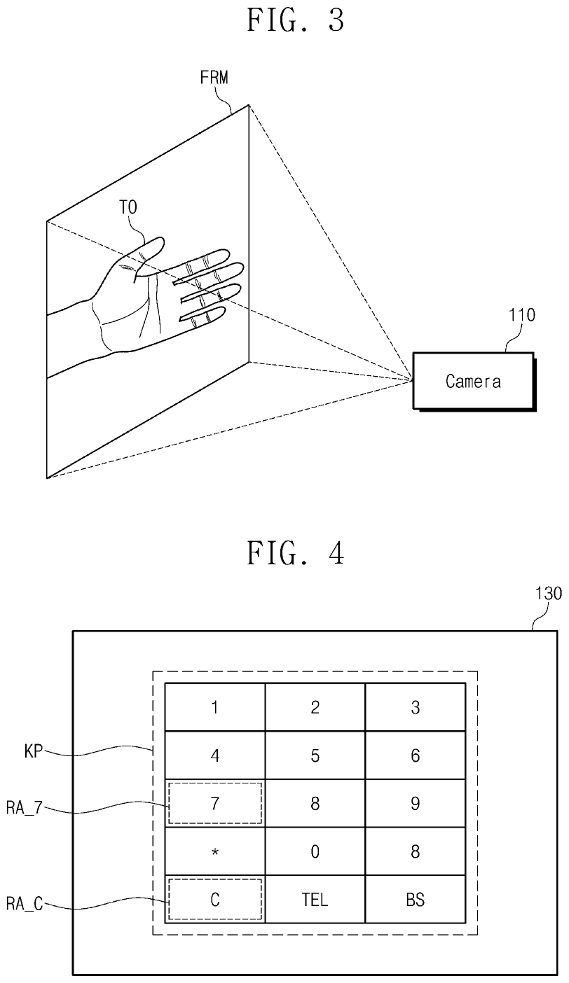

In an embodiment, the target object may include one of various types of objects such as a user's hand (e.g., a palm or back of his/her hand), a wrist, and a paper. That is, the scope of the invention is not limited to a type of the target object. However, below, for brief description, an embodiment in which the target object corresponds to the user's palm. How to recognize the target object will be described in detail with reference to FIG. 3.

In an embodiment, the key pad may be a telephone dial pad. For example, the keypad may include number keys “0” to “9”, symbol keys “*” and “#”, a cancel key, a call key, and a backspace key. The number keys “0” to “9” may respectively correspond to key values of “0” to “9”. The symbol key “*” may correspond to a key value of “*”. The symbol key “#” may correspond to a key value of “#”. The cancel key may correspond to a key value of “Cancel”. The call key may correspond to a key value of “Call”. The backspace key may correspond to a key value of “Backspace”.

The key pad may include a plurality of reference areas. For example, the plurality of reference areas may respectively correspond to different key values. In detail, when the key pad is a telephone dial pad, the plurality of reference areas may respectively correspond to the key values of “0” to “9”, “*”, “#”, “Cancel”, “Call”, and “Backspace”.

The processor 120 may identify a pointing object on the frame photographed by the camera 110. The processor 120 may identify an area on the photographed frame, which the identified pointing object points out. Below, for brief description, the area that the pointing object points out may be referred to as a “pointing area”.

The processor 120 may compare the pointing area and the reference area to recognize a key value input by the user. For example, when it is determined that a first reference area among the plurality of reference areas corresponds to the pointing area, the processor 120 may determine that a first key value corresponding to the first reference area is input by the user.

In detail, for example, the processor 120 may identify first coordinates being coordinates of the pointing area on the photographed frame. The processor 120 may identify second coordinates of a location on the monitor 130, which corresponds to the first coordinates. The processor 120 may determine that the first reference area including the second coordinates from among the plurality of reference areas corresponds to the pointing area.

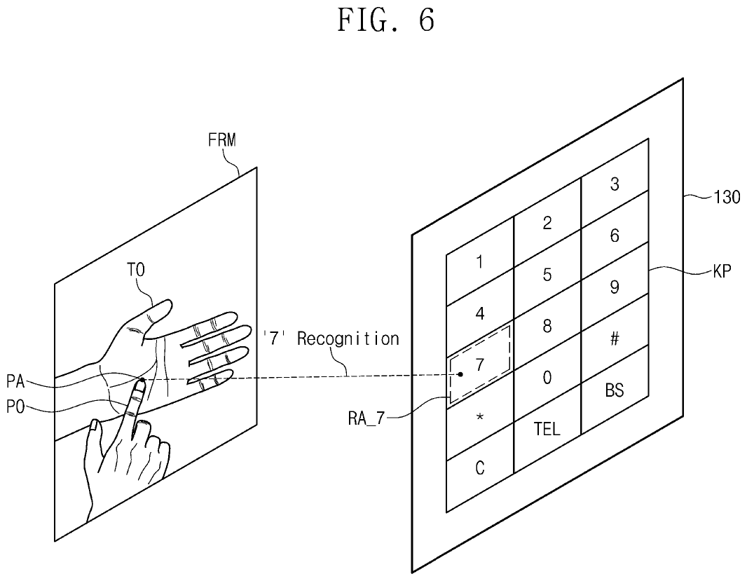

In an embodiment, the pointing object may include one of various types of objects such as a finger, a pen, and a stick. That is, the scope of the invention is not limited to a type of the pointing object. However, below, for brief description, an embodiment in which the pointing object corresponds to the user's finger. How to recognize the pointing object will be described in detail with reference to FIG. 5.

In an embodiment, the pointing area may be determined depending on a location of the end (terminal) of the pointing object. For example, the pointing area may correspond to a location of the user's fingertip.

In an embodiment, when the pointing area corresponds to a specific reference area during a given time length (i.e., when the user continuously inputs (e.g., presses, touches) a specific key during the given time length), the processor 120 may call a shortcut function. For example, the processor 120 may call a phone number on speed dial stored in the memory 140. In this case, the phone number on speed dial may be differently set for each key value.

The memory 140 may be used for the operation of the processor 120. For example, the memory 140 may temporarily store data of images photographed through the camera 110, may provide a space for computation/calculation of the processor 120, and may be used to load data such as firmware executable by the processor 120.

The memory 140 may store key values identified as the user inputs. For example, when it is determined that the user sequentially inputs key values of ‘0’,‘1’,‘0’,‘1’,‘2’,‘3’,‘4’,‘5’,‘6’,‘7’, and ‘8’, the memory 140 may store “01012345678”.

The communication module 150 may perform the communication function based on key values identified as the user inputs. For example, when it is determined that the user inputs the key value of “Call”, with “01012345678” stored in the memory 140, the communication module 150 may support the communication with number (e.g., phone number) “01012345678”.

In an embodiment, the communication module 150 may internally support the communication function without the connection (e.g., pairing) with any other smart device. That is, instead of supporting the communication function using the smartphone, the communication module 150 may internally support the communication function. For example, the communication module 150 may internally perform the communication function complying with one of communication protocols such as GSM (Global System for Mobile communication), WCDMA (Wideband Code Division Multiple Access), LTE (Long Term Evolution), LTE-A (LTE-advanced), and NR (New Radio). However, the present disclosure is not limited thereto. For example, the communication module 150 may support the communication function using the smartphone, based on a short-range wireless communication protocol such as Bluetooth, NFC (Near Field communication), or Wi-Fi (Wireless Fidelity).

In an embodiment, in the case where the communication module 150 internally supports the communication function, even though the user does not carry the smartphone always, the user may use the communication function. In this case, because the user's need to carry the smartphone is reduced, the convenience of the user is increased, and the risk of losing the smartphone may be reduced.

According to an embodiment of the present disclosure, the communication function may be performed by the user's hand photographed through the camera 110. In this case, even though the user does not directly touch the smart glasses 100 with his/her hand, the user may use the communication function. As such, the convenience of the user may be improved. Also, even though the user himself/herself does not search for and execute the application supporting the communication function, the user may perform the communication function by allowing his/her hand to be recognized through the camera 110 of the smart glasses 100. Accordingly, the convenience of the user may be improved.

FIG. 2 is a perspective view illustrating smart glasses illustrated in FIG. 1. Referring to FIGS. 1 and 2, the smart glasses 100 may include the camera 110, a first monitor 130a, a second monitor 130b, a first support 160a, a second support 160b, and a glass frame 170.

The first and second monitors 130a and 130b may be respectively provided at lens locations of the smart glasses 100. That is, when the user wears the smart glasses 100, the first and second monitors 130a and 130b may be close to both eyes of the user. The first and second monitors 130a and 130b may be disposed on the same plane. However, the number of monitors according to the present disclosure is not limited to the above example. For example, the smart glasses 100 may include only one of the first and second monitors 130a and 130b.

In an embodiment, the monitor 130 of FIG. 1 may correspond to one of the first and second monitors 130a and 130b.

The camera 110 may be provided at one end (or terminal) of the smart glasses 100. For example, the camera 110 may be disposed to face a direction perpendicular to a plane where the first and second monitors 130a and 130b are disposed, such that an image corresponding to the line of sight of the user is photographed. However, the present disclosure is not limited thereto. The camera 110 may be disposed at the center of the smart glasses 100 (e.g., between the first and second monitors 130a and 130b of the smart glasses 100) or may be disposed at opposite ends (or endpieces) of the smart glasses 100 (i.e., in the shape of a dual camera).

The first support 160a and the second support 160b may be respectively disposed at the opposite ends of the smart glasses 100. In this case, when the user wears the smart glasses 100, the first and second supports 160a and 160b may respectively be close to the user's ears.

The glass frame 170 may fix the first and second monitors 130a and 130b, the first and second supports 160a and 160b, and the camera 110. That is, the first and second monitors 130a and 130b, the first and second supports 160a and 160b, and the camera 110 may be coupled to the glass frame 170. The glass frame 170 may include the processor 120, the memory 140, and the communication module 150 of FIG. 1. That is, the processor 120, the memory 140, and the communication module 150 may be disposed at an arbitrary location within the glass frame 170.

However, the above configuration of the smart glasses 100 is provided as an example, and the present disclosure is not limited thereto. For example, the smart glasses 100 according to the present disclosure may be implemented in various shapes, such as headset and neck band, without being limited to the above shape

FIG. 3 is a diagram illustrating an operation of smart glasses of FIG. 1. Referring to FIGS. 1 and 3, the camera 110 may photograph a frame FRM corresponding to the line of sight of the user. For example, the frame FRM may refer to an image corresponding to a plurality of pixels of the camera 110, which are capable of simultaneously taking a picture at a specific time.

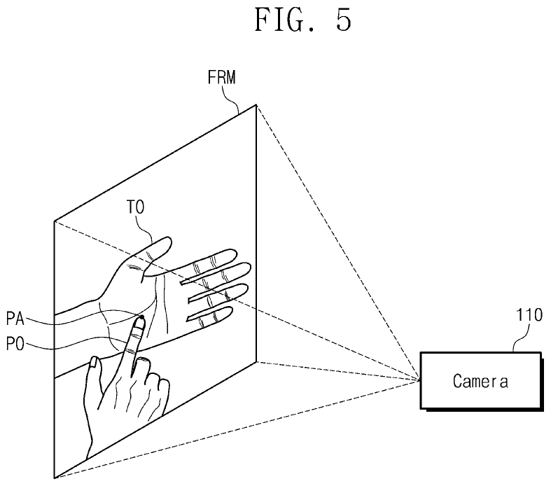

The processor 120 may analyze the frame FRM photographed through the camera 110 and may determine whether a target object TO is included on the frame FRM. When it is determined that the target object TO is included on the frame FRM (i.e., when the target object TO is identified on the frame FRM), the processor 120 may allow the monitor 130 to display the key pad. How the monitor 130 displays the key pad will be described in detail with reference to FIG. 4.

When it is determined that the target object TO is not included on the frame FRM, under control of the processor 120, the monitor 130 may not display the key pad. That is, in response to that the user moves out his/her palm in front of the camera 110, the processor 120 may allow the monitor 130 to stop displaying the key pad.

In an embodiment, the target object TO may correspond to the user's palm. However, the present disclosure is not limited thereto. For example, the target object TO may correspond to the back of user's hand.

In an embodiment, only when the entire target object TO is included on the frame FRM, the processor 120 may be configured to determine that the target object TO is included on the frame FRM. For example, only when the entire palm of the user is included on the frame FRM, the key pad may be displayed on the monitor 130; when only a part of the user's palm is included on the frame FRM, the key pad may not be displayed on the monitor 130. However, the present disclosure is not limited thereto.

FIG. 4 is a diagram illustrating an operation in which a monitor of FIG. 1 displays a key pad when a target object is recognized. Referring to FIGS. 1, 3, and 4, the monitor 130 may display a key pad KP in response to determining that the target object TO is included on the frame FRM.

The key pad KP may include a telephone dial pad. For example, the key pad KP may include number keys “0” to “9”, symbol keys “#” and “# and” a cancel key, a call key, and a backspace key. In this case, the number keys “0” to “9” may respectively correspond to key values of “0” to “9”. The cancel key (in FIG. 4, shown as “C”) may correspond to the “cancel” key value. The call key (in FIG. 4, shown as “TEL”) may correspond to the “call” key value. The backspace key (in FIG. 4, shown as “BS”) may correspond to the “backspace” key value.

Different reference areas may be allocated for different key values. For example, the “7” reference area RA_7 may be allocated for the number key “7”, and the “C” reference area RA_C may be allocated for the cancel key “C”. However, the present disclosure is not limited thereto. For example, different reference areas may be allocated for the above keys.

In an embodiment, the reference area may be determined to have the same size as the corresponding key on the display.

In an embodiment, the monitor 130 may display the key pad KP in the transparent or translucent form.

In an embodiment, the size of the key pad KP may be determined based on the size of the target object TO on the frame FRM of FIG. 3. For example, as the user's palm comes closer to the camera 110, the size of the key pad KP may increase; and as the user's palm comes more distant from the camera 110, the size of the key pad KP may decrease.

FIG. 5 is a diagram illustrating an operation in which smart glasses of FIG. 1 determine a pointing area. Referring to FIGS. 1 and 3 to 5, the processor 120 may analyze the frame FRM and may determine whether a pointing object PO is included in the frame FRM. The processor 120 may identify an area (i.e., a pointing area PA) that the pointing object PO points out.

In an embodiment, the pointing object PO may correspond to the user's finger. The pointing area PA may correspond to a location of the fingertip of the user.

In an embodiment, the pointing area PA may be determined regardless of whether the fingertip of the user is in contact with the user's palm. For example, the pointing area PA may be determined based on the location of the fingertip of the user, which is detected through the camera 110.

In an embodiment, the pointing area PA may be determined in response to that the fingertip of the user is in contact with the user's palm (i.e., the target object TO). For example, as the fingertip of the user is in contact with the user's palm, the pointing area PA may be determined based on a curve in the skin of the user's palm which occurs by the contact. That is, the processor 120 may detect the curve of the user's palm on the frame FRM to determine the pointing area PA. In this case, the location of the pointing area PA may be determined more accurately.

In an embodiment, the pointing area PA may be determined based on a location of a recognition pad attacked to the fingertip of the user. For example, the user may attach the recognition pad to his/her fingertip, and the processor 120 may detect the location of the recognition pad to determine the pointing area PA. In this case, the location of the pointing area PA may be determined more accurately.

In an embodiment, the processor 120 may identify coordinates of the pointing area PA on the frame FRM. For example, the processor 120 may identify (x1, y1) being coordinates on the frame FRM, at which the pointing area PA is placed. The identified coordinates may be used to identify the reference area on the key pad KP displayed in the monitor 130. How to identify the reference area on the key pad KP by using coordinates at which the pointing area PA is placed will be described in detail with reference to FIG. 6.

FIG. 6 is a diagram illustrating an operation in which smart glasses of FIG. 1 recognize an input key value based on a pointing area. Referring to FIGS. 1 and 3 to 6, a key value on the key pad KP may be recognized based on a location of the pointing area PA. For example, the processor 120 may identify (x1, y1) being coordinates on the frame FRM, at which the pointing area PA is placed. The processor 120 may identify (x2, y2) on the monitor 130, which is coordinates corresponding to (x1, y1). The processor 120 may identify the reference area including the coordinates (x2, y2). The processor 120 may recognize the key value corresponding to the identified reference area.

In detail, for example, when it is determined that the “7” reference area RA_7 includes the coordinates (x2, y2), the processor 120 may recognize that the user inputs the number key “7”. In this case, the processor 120 may store the key value “7” in the memory 140.

As in the above description, when the processor 120 recognizes that the user inputs the symbol key “*” or “#”, the processor 120 may store the key value corresponding to the input key in the memory 140.

When the processor 120 recognizes that the user inputs the cancel key “C”, the processor 120 may erase all the key values stored in the memory 140.

When the processor 120 recognizes that the user inputs the backspace key “BS”, the processor 120 may erase a key value stored most recently from among the key values stored in the memory 140.

When the processor 120 recognizes that the user inputs the call key “TEL”, the processor 120 may support communication with a phone number corresponding to the key values stored in the memory 140 through the communication module 150.

In an embodiment, when the processor 120 recognizes that the user presses a specific number key during a given time length, the processor 120 may perform a shortcut function allocated to the specific number key. For example, when it is determined that the user continuously presses the number key “7” for 3 seconds, the processor 120 may perform the shortcut function allocated to the number key “7”.

In an embodiment, the shortcut function may include a function of starting communication with a given phone number. For example, when it is determined that the number key “7” is continuously pressed for 3 seconds, the processor 120 may start communication with a phone number “when it is determined that the user continuously presses the number key “7” for 3 seconds,” that is determined in advance and is stored in the memory 140. However, the present disclosure is not limited thereto.

In an embodiment, the monitor 130 may display a location on the monitor 130, which corresponds to the pointing area. For example, the monitor 130 may display the location corresponding to the above coordinates (x2, y2). In this case, the user may in advance confirm whether any key on the key pad KP is recognized, and thus, the convenience of the user may be improved.

In an embodiment, when a specific key on the key pad KP is recognized, the monitor 130 may feed it back to the user. For example, in response to that a specific key is recognized, the monitor 130 may highlight the recognized key under control of the processor 120. In detail, one of color (or hue), brightness (or value), and saturation values of the reference area corresponding the recognized key may be temporarily changed. In this case, the user may immediately perceive the recognized key, and thus, the convenience of the user may be improved.

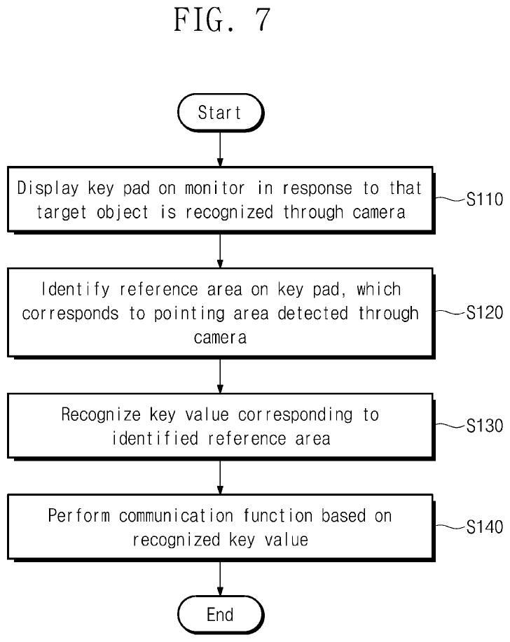

FIG. 7 is a flowchart illustrating an operation method of smart glasses of FIG. 1. Referring to FIGS. 1 and 3 to 7, in operation S110, the smart glasses 100 may display the key pad KP on the monitor 130 in response to that the target object TO is recognized through the camera 110. For example, the processor 120 may determine whether the target object TO is included in the frame FRM photographed through the camera 110. When it is determined that the target object TO is included in the frame FRM, the processor 120 may allow the monitor 130 to display the key pad KP. When it is determined that the target object TO is not included in the frame FRM, under control of the processor 120, the monitor 130 may not display the key pad KP.

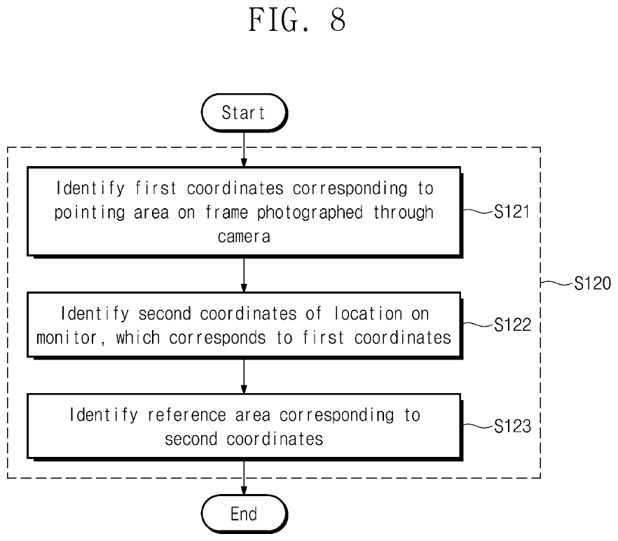

In operation S120, the smart glasses 100 may identify the reference area on the key pad KP, which corresponds to the pointing area PA detected through the camera 110. For example, the processor 120 may identify the reference area on the key pad KP corresponding to the pointing area PA, based on a relative location of the pointing area PA in the frame FRM. How to identify the reference area corresponding to the pointing area PA based on a location of the pointing area PA will be described in detail with reference to FIG. 8.

In operation S130, the smart glasses 100 may recognize the key value corresponding to the identified reference area. For example, the processor 120 may recognize the key value corresponding to the reference area identified in operation S120. In detail, for example, when the “7” reference area RA_7 is identified in operation S120, the processor 120 may recognize the key value “7” and may store the recognized key value in the memory 140.

In operation S140, the smart glasses 100 may perform the communication function based on the recognized key value. For example, the processor 120 may store the recognized key value in the memory 140. In response to that the “call” key value is recognized, the processor 120 may start communication with a phone number corresponding to the key values stored in the memory 140.

In an embodiment, according to an embodiment of the present disclosure, the user of the smart glasses 100 may perform the communication function without a smartphone only by wearing the smart glasses 100 and moving his/her hand, and thus, the convenience of the user may be improved.

FIG. 8 is a flowchart illustrating operation S120 of FIG. 7 in detail. Referring to FIGS. 1 and 3 to 8, operation S120 may include operation S121 to operation S123. In operation S121, the smart glasses 100 may identify first coordinates corresponding to the pointing area PA on the frame FRM photographed through the camera 110. That is, the processor 120 may identify coordinates indicating a relative location of the pointing area PA on the frame FRM.

In operation S122, the smart glasses 100 may identify second coordinates of a location on the monitor 130, which corresponds to the first coordinates. For example, the processor 120 may identify second coordinates corresponding to the first coordinates identified in operation S121 from among a plurality of coordinates on the monitor 130.

In operation S123, the smart glasses 100 may identify the reference area corresponding to the second coordinates. For example, the processor 120 may identify the reference area including the second coordinates. In detail, for example, when the second coordinates are included in the “7” reference area RA_7, the processor 120 may identify the “7” reference area RA_7.

According to an embodiment of the present disclosure, smart glasses that recognize a hand of the user to perform a communication function and an operation method thereof may be provided. Accordingly, high convenience may be provided to the user of the smart glasses according to an embodiment of the present disclosure.

While the present disclosure has been described with reference to embodiments thereof, it will be apparent to those of ordinary skill in the art that various changes and modifications may be made thereto without departing from the spirit and scope of the present disclosure as set forth in the following claims.

1. An operation method of smart glasses, the method comprising:
providing a first monitor and a second monitor each at a lens location of the smart glasses;
displaying a key pad on at least one of the first monitor and the second monitor in response to that a target object is recognized through a camera;
identifying a reference area on the displayed key pad, which corresponds to a pointing area detected through the camera;
recognizing a key value corresponding to the identified reference area; and
performing a communication function based on the recognized key value.

2. The method of claim 1, wherein the target object is a palm of the user of the smart glasses.

3. The method of claim 2, further comprising:
stopping displaying the key pad in response to that the palm of the user is not recognized through the camera.

4. The method of claim 2, wherein the identifying of the reference area includes:
identifying first coordinates corresponding to the pointing area on a frame photographed through the camera;
identifying second coordinates on the key pad, which correspond to the first coordinates; and
identifying the reference area corresponding to the second coordinates.

5. The method of claim 4, further comprising:
when the second coordinates are maintained during a first time length,
performing a shortcut function corresponding to the identified reference area.

6. The method of claim 5, wherein the shortcut function is a function of starting communication with a given phone number.

7. The method of claim 4, wherein the pointing area is determined depending on a fingertip of the user.

8. The method of claim 7, wherein the pointing area is determined in response to that the fingertip is in contact with the palm.

9. The method of claim 8, wherein the pointing area is determined based on a curve in a skin of the palm, which is formed when the fingertip is in contact with the palm.

10. The method of claim 4, wherein the pointing area is determined depending on a location of a recognition pad attached to a fingertip of the user.

11. The method of claim 1, wherein the monitor is translucent or transparent.

12. The method of claim 1, wherein the key pad is a telephone dial pad.

13. The method of claim 1, wherein a size of the key pad is determined based on a size of the target object on a frame photographed through the camera.

14. Smart glasses comprising:
a camera configured to photograph a frame corresponding to the line of sight of a user;
a processor configured to identify a target object and a pointing area on the frame;
a monitor configured to display a key pad in response to that the target object is identified by the processor; and
a communication module configured to perform a communication function based on a key value,
wherein the key value is determined based on a reference area on the key pad, which corresponds to the pointing area,
wherein the monitor comprises a first monitor and a second monitor corresponding respectively provided at a lens location of the smart glasses, and
wherein the first and second monitors are disposed proximal to both eyes of the user and the first and second monitors are disposed on the same plane.

15. The smart glasses of claim 14, wherein the target object is a palm of the user.

16. The smart glasses of claim 14, wherein the pointing area is determined depending on a fingertip of the user.

17. The smart glasses of claim 14, wherein the monitor is further configured to:
stop displaying the key pad in response to that the target object is not recognized by the processor.

18. The smart glasses of claim 14, wherein the monitor is further configured to:
display the key pad to be translucent or transparent.

19. The smart glasses of claim 14, wherein a size of the key pad is determined based on a size of the target object on a frame photographed through the camera.

20. The smart glasses of claim 14, wherein the communication module is further configured to:
perform the communication function complying with a communication protocol corresponding to one of GSM (Global System for Mobile communication), WCDMA (Wideband Code Division Multiple Access), LTE (Long Term Evolution), LTE-A (LTE-advanced), and NR (New Radio).
